(19) United States
(12) Patent Application Publication
(10) Pub. No.: US 2007/0125597 A1
(43) Pub. Date: Jun. 7, 2007

(54) Fence crossing aid

(76) Inventor: William C. Howerton, Blanchard, OK (US)

Correspondence Address: James T. Robinson;Exclusivity-Law, Inc, 222 East Main Street, Norman, OK, 73069-1303, US

(21) Appl. No.: 11/291,615

(22) Filed: Dec. 1, 2005

(51) Int. Cl. E06C 9/00

(52) U.S. Cl. 182/92

(57) ABSTRACT

A fence crossing aid to assist a user in crossing a fence supported by a T-post provides a vertical member having a bottom portion terminating in a bottom end and an upper portion terminating in an upper end, a stepping bar assembly attached to the lower end of the vertical member, a handlebar assembly attached to the upper end of the vertical member, a strap attached to the bottom portion of the vertical member for securing the vertical member to the T-post, and an inverted L-shaped mounting head attached to the upper portion of the vertical member so the top of the T-post is received within the inverted L-shaped mounting head and the T-post supports the combined weight of the fence crossing aid and the user.

### BACKGROUND OF INVENTION

1. Field of the Invention

Applicant's invention relates generally to tools used in outdoor activities, and more particularly but not by way of limitation, to an aid for crossing fences supported by standard T-posts.

2. Discussion

In many areas of the United States and other countries, strands of barbed wire are supported by T-posts to create a fence. Barbed wire is effective not only in retaining cattle and other livestock, but also in making access troublesome for humans. In petroleum-producing regions, land managers and oil company personnel often find it necessary to cross barbed wire fences in the course of their normal job duties. Hunters and fisherman must also deal with barbed wire fences. Individuals can either crawl under the bottommost strand of barbed wire, step through adjacent strands of barbed wire, or climb over the topmost strand. In the process achieving access to an area fenced off by barbed wire, the individuals frequently experience torn clothing or lacerations to skin.

What is needed is a device which facilitates entry into an area circumscribed by barbed wire fencing. The device should be light weight and compact for ease of transport. Yet the device must be capable of supporting the weight of a typical man or woman.

### SUMMARY OF THE INVENTION

A fence crossing aid to assist a user in crossing a fence supported by a T-post provides a vertical member having a bottom portion terminating in a bottom end and an upper portion terminating in an upper end, a stepping bar assembly attached to the lower end of the vertical member, a handlebar assembly attached to the upper end of the vertical member, a strap attached to the bottom portion of the vertical member for securing the vertical member to the T-post, and an inverted L-shaped mounting head attached to the upper portion of the vertical member so the top of the T-post is received within the inverted L-shaped mounting head and the T-post supports the combined weight of the fence crossing aid and the user. The vertical member can be a telescoping vertical member. The stepping bar assembly and the handlebar assembly may be pivotally mounted to the vertical member.

The advantages and features of the present invention will be apparent from the following description when read in conjunction with the accompanying drawings and appended claims.

### BRIEF DESCRIPTION OF THE DRAWINGS

FIG. 1 is a view of a fence crossing aid according to applicant's invention.

FIG. 2 is a view showing the fencing cross aid of FIG. 1 in use by a person crossing a fence supported by a T-post.

FIG. 3 is another view showing the fencing cross aid of FIG. 1 in use by a person crossing a fence supported by a T-post.

FIG. 4 is another view showing the fencing cross aid of FIG. 1 in use by a person crossing a fence supported by a T-post.

FIG. 5 is an enlarged view of the fence crossing aid shown in FIGS. 1-4.

FIG. 6 is another enlarged view of the fence crossing aid shown in FIGS. 1-5.

FIG. 7 is an enlarged cross-sectional view along 7-7 in FIG. 5 of the fence crossing aid shown in FIGS. 1-6.

FIG. 8 is a view of another fence crossing aid according to applicant's invention.

FIG. 9 is a view of a portion of another fence crossing aid according to applicant's invention.

FIG. 10 is another view of the fence crossing aid shown in FIG. 9.

FIG. 11 is a view of a portion of another fence crossing aid according to applicant's invention.

FIG. 12 is another view of the fence crossing aid shown in FIG. 11.

### DETAILED DESCRIPTION

In the following description of the invention, like numerals and characters designate like elements throughout the figures of the drawings.

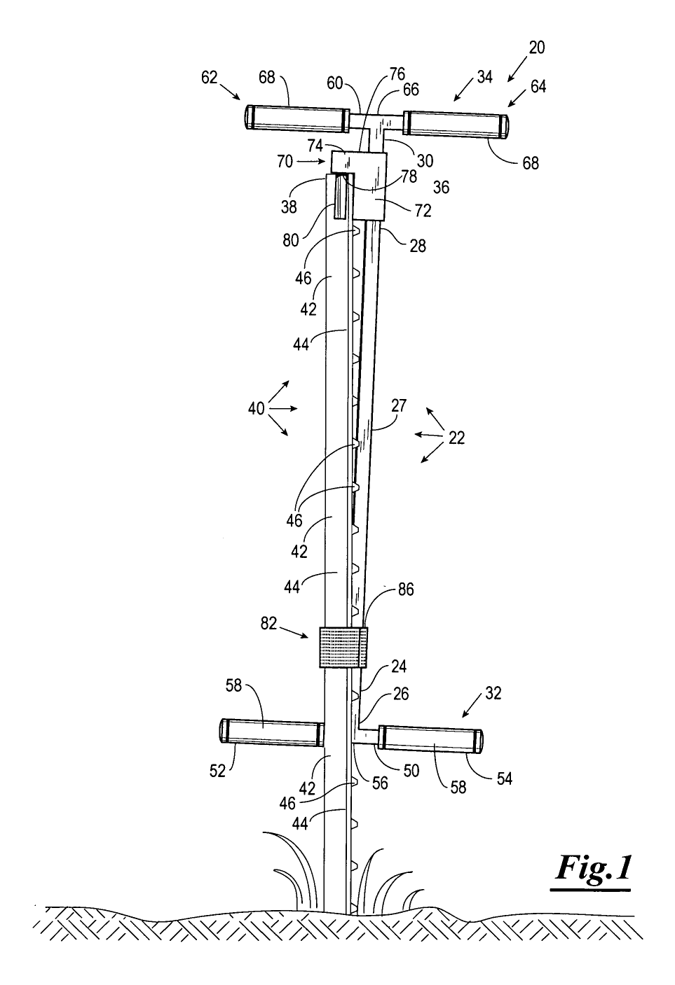

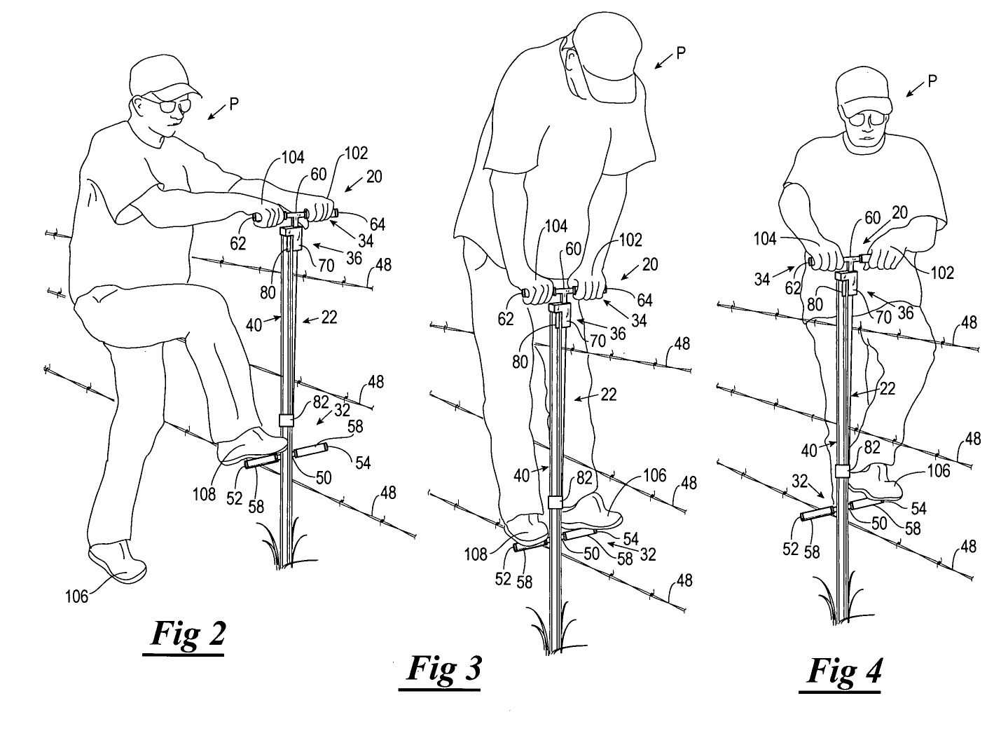

Referring to FIG. 1, a fence crossing aid 20 is shown. A vertical member 22 has a lower portion 24 terminating in a lower end 26, an intermediate portion 26, and an upper portion 28 terminating in an upper end 30. A stepping bar assembly 32 is attached to the lower end 26 of the vertical member 22, and a handlebar assembly 34 is attached to the upper end 30 of the vertical member 22. A T-post gripping head 36 attached to the vertical member 22 near the upper end 30 of the vertical member 22 receives the top 38 of a T-post 40 and supports the weight of the user (see FIGS.2-4). The T-post 40 includes a rib member 42, a cross-member 44 perpendicular to the rib member 42, and spaced protrusions 46 on the cross-member 44 opposite the rib member 42. The spaced protrusions 46 permit the fixed location of individual strands of barbed wire 48 (see FIGS. 2-4).

Still referring to FIG. 1, the stepping bar assembly 32 consists of a horizontal foot member 50 with end portions 52, 54 and a mid-portion 56. The foot member 50 is attached to the lower end 26 of the vertical member 22 at the horizontal foot member mid-portion 56. Grips 58 attached to the end portions 52, 54 provide a reliable stepping surface for the user.

Still referring to FIG. 1, the handlebar assembly 34 consists of a horizontal hand member 60 with end portions 62, 64 and a handlebar mid-portion 66. The horizontal hand member 60 is attached to the upper end 30 of the vertical member 22 at the horizontal hand member mid-portion 66. Grips 68 attached to the end portions 62, 64 provide a reliable hand-gripping surface for the user.

Still referring to FIG. 1, the T-post mounting head 36 has an inverted L-shaped solid body 70 with a vertical longer portion 72 and a horizontal shorter portion 74 having a top 76 and a bottom 78. Two vertical positioning members 80 extend downwardly from the bottom 78 of the horizontal shorter portion 74 of the inverted L-shaped solid body 70. The vertical positioning members 80 are generally parallel to the vertical longer portion 72 of the inverted L-shaped solid body 70 of the T-post mounting head 36. The T-post mounting head 36 is placed over the top 38 of the T-post 40 so the vertical positioning members 80 extend downwardly along each side of the T-post rib 42 adjacent the T-post cross member 44.

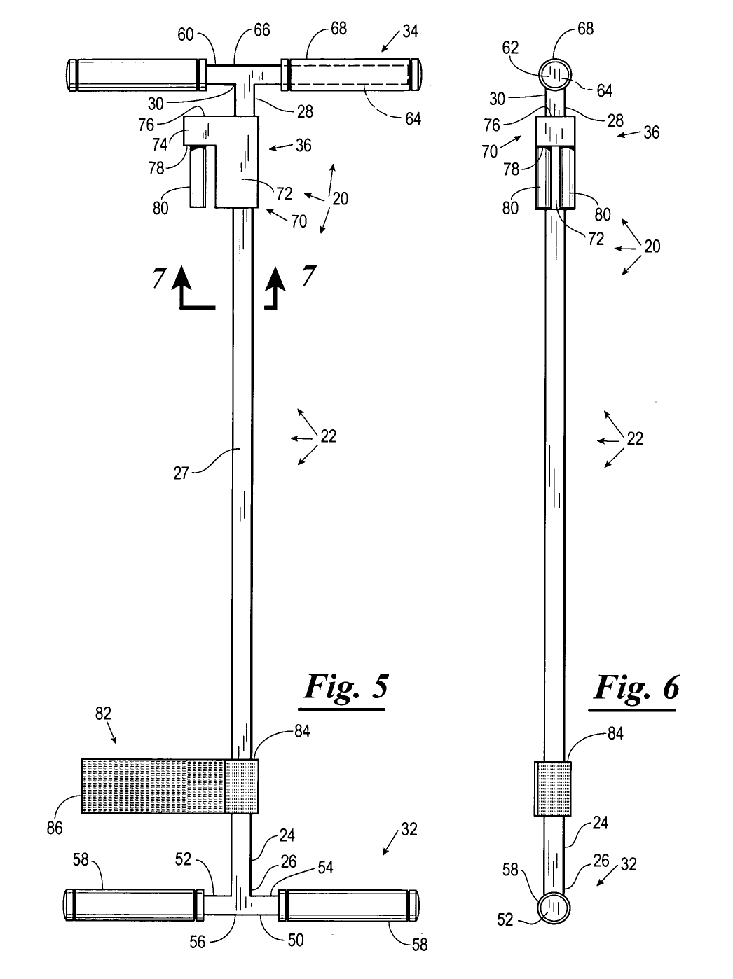

Still referring to FIG. 1, a strap 82 has an end 84 attached to the vertical member 22. A loose end 86 secures the lower portion 24 of the vertical member 22 against the T-post 40. The details of the strap 82, the attached end 84, and the loose end 86 are shown in greater detail in FIG. 5.

Referring now to FIGS. 2-4, a user P with left hand 102, right hand 104, left foot 106, and right foot 108 uses the fence crossing aid 20 to cross a barbed wire fence consisting of three strands 48 of barbed wire attached to a T-post 40. While placing his hands 102,104 on the grips 48 of the end portions 64, 62, respectively, of the horizontal handlebar member 60, the user P first places his right foot 108 on the grip 58 attached to the end portion 52 of the horizontal foot member 50 (FIG. 2). Next, the user P lifts his weight upwardly, swings his left foot 106 over the topmost strand 48 of barbed wire, and places his left foot 106 on the grip 58 attached to the end portion 54 of the horizontal foot member 50 (FIG. 3). Finally, the user P swings his right foot 108 up and over the topmost strand 48 of barbed wire, lowers his weight while maintaining this left foot 106 in contact with the grip 58 attached to the end portion 54 of the horizontal foot member 50, and places his right foot 108 on the ground (FIG. 4). As shown in FIGS. 2-4, the mounting head 36 is supported by the top of the T-post 40 and the strap 82 secures the bottom portion 24 of the vertical member 22 of the fence crossing aid 20 to the T-post 40.

Referring now to FIGS. 5 and 6, an enlarged view of the fence crossing aid 20 shows the strap 86 slidably attached to the vertical member 22 for securing the bottom portion 24 of the fence crossing aid 20 to the T-post 40 (See FIGS. 1-4). The strap 86 shown in FIG. 5 is a common hook-and-loop fastener. The end 84 is slidably attached to the vertical member 22. The loose end 86 is wrapped around the T-post 40 and secured to itself as shown in FIGS. 1-4.

Still referring to FIGS. 5-6, the grip 68 is attached to the end portion 64 of the horizontal hand member 60. In FIG. 6, the positioning members 80 extend downwardly from the bottom 78 of the horizontal portion 74 of the inverted L-shaped body 70 of the mounting head 36. As seen in FIGS. 1-4, the positioning members 80 fit on either side of the rib member 42 of the T-post 40.

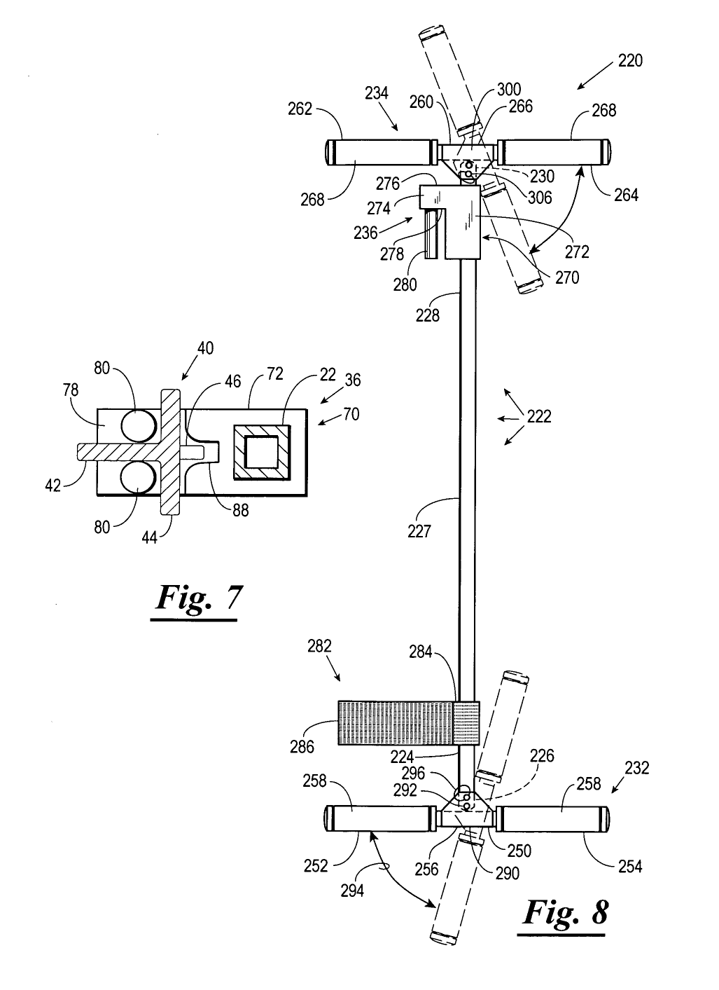

Referring now to FIG. 7, a cross-section along 7-7 in FIG. 5 shows the mounting head 36 attached to the vertical member 22. For clarity, a cross-section of the T-post 40 is also shown in phantom. The positioning members 80 extend downwardly from the bottom 78 of the horizontal portion 74 of the inverted L-shaped body 70 of the mounting head 36. A recess 88 (also referred to, alternatively, as a “notch” or a “cutout”) in the vertical portion 72 of the inverted L-shaped body 70 receives the spaced protrusion 46 on the cross member 44 of the T-post 40.

Referring now to FIG. 8, another fence crossing aid 220 is shown. A vertical member 222 has a lower portion 224 terminating in a lower end 226, an intermediate portion 227, and an upper portion 228 terminating in an upper end 230. A stepping bar assembly 232 is attached to the lower end 226 of the vertical member 222, and a handlebar assembly 234 is attached to the upper end 230 of the vertical member 222. A T-post gripping head 236 attached to the vertical member 222 near the upper end 230 of the vertical member 222 receives the top 38 of the T-post 40 and supports the weight of the user (see FIGS. 1-4). The T-post 40 includes a rib member 42, a cross-member 44 perpendicular to the rib member 42, and spaced protrusions 46 on the cross-member 44 opposite the rib member 42. The spaced protrusions 46 permit the fixed location of individual strands of barbed wire 48 (see FIGS. 2-4).

Still referring to FIG. 8, the stepping bar assembly 232 consists of a horizontal foot member 250 with end portions 252, 254 and a mid-portion 256. The foot member 250 is attached to the lower end 226 of the vertical member 222 at the horizontal foot member mid-portion 256. Grips 258 attached to the end portions 252, 254 provide a reliable stepping surface for the user.

Still referring to FIG. 8, the handlebar assembly 234 consists of a horizontal hand member 260 with end portions 262, 264 and a handlebar mid-portion 266. The horizontal hand member 260 is attached to the upper end 230 of the vertical member 222 at the horizontal hand member mid-portion 266. Grips 268 attached to the end portions 262, 264 provide a reliable hand-gripping surface for the user.

Still referring to FIG. 8, the T-post mounting head 236 has an inverted L-shaped solid body 270 with a vertical longer portion 272 and a horizontal shorter portion 274 having a top 276 and a bottom 278. Two vertical positioning members 280 extend downwardly from the bottom 278 of the horizontal shorter portion 274 of the inverted L-shaped solid body 270. The vertical positioning members 280 are generally parallel to the vertical longer portion 272 of the inverted L-shaped solid body 270 of the T-post mounting head 236. As shown in FIGS. 1-4, the T-post mounting head 236 is placed over the top 38 of the T-post 40 so the vertical positioning members 280 extend downwardly along each side of the T-post rib 42 adjacent the T-post cross member 44.

Still referring to FIG. 8, a strap 282 has an end 284 attached to the vertical member 222. A loose end 286 secures the lower portion 224 of the vertical member 222 against the T-post 40. The strap 282, the attached end 284, and the loose end 286 are identical to those shown in FIG. 5.

Still referring to FIG. 8, a collar 290 attached to the mid-portion 256 of the horizontal foot member 250 is pivotally attached to the vertical member 222 adjacent the end 226 of the vertical member 222 by a fastener 292. The end portion 252 of the horizontal foot member 250 moves as indicated by arrow 294 when the horizontal foot member 250 is pivoted between a use position, indicated by solid lines, and a storage position, as indicated in phantom. When the horizontal foot member 250 is positioned in the use position, a pull pin 296 extends through bores (not shown) in the collar 290 and aligned bores (not shown) in the vertical member 222 adjacent the end 226.

It will be understood by one skilled in the art that the collar 290 can be welded to the horizontal foot member 250 or, in the alternative, the collar 290 can be an integral part of the horizontal foot member 250. The fastener 292 can be a rivet or a nut-bolt assembly.

Still referring now to FIG. 8, another collar 300 attached to the mid-portion 266 of the horizontal hand member 260 is pivotally attached to the vertical member 222 adjacent the end 230 by a fastener 302. The end portion 264 of the horizontal hand member 260 moves as indicated by arrow 304 when the horizontal hand member 260 is pivoted between a use position, indicated by solid lines, and a storage position, as indicated in phantom. When the horizontal hand member 260 is positioned in the use position, a pull pin 306 extends through bores (not shown) in the collar 300 and aligned bores (not shown) in the vertical member 222 adjacent the end 230. The collar 300 can be welded to the horizontal hand member 260 or, in the alternative, the collar 300 can be an integral part of the horizontal hand member 260. The fastener 302 can be a rivet or a nut-bolt assembly.

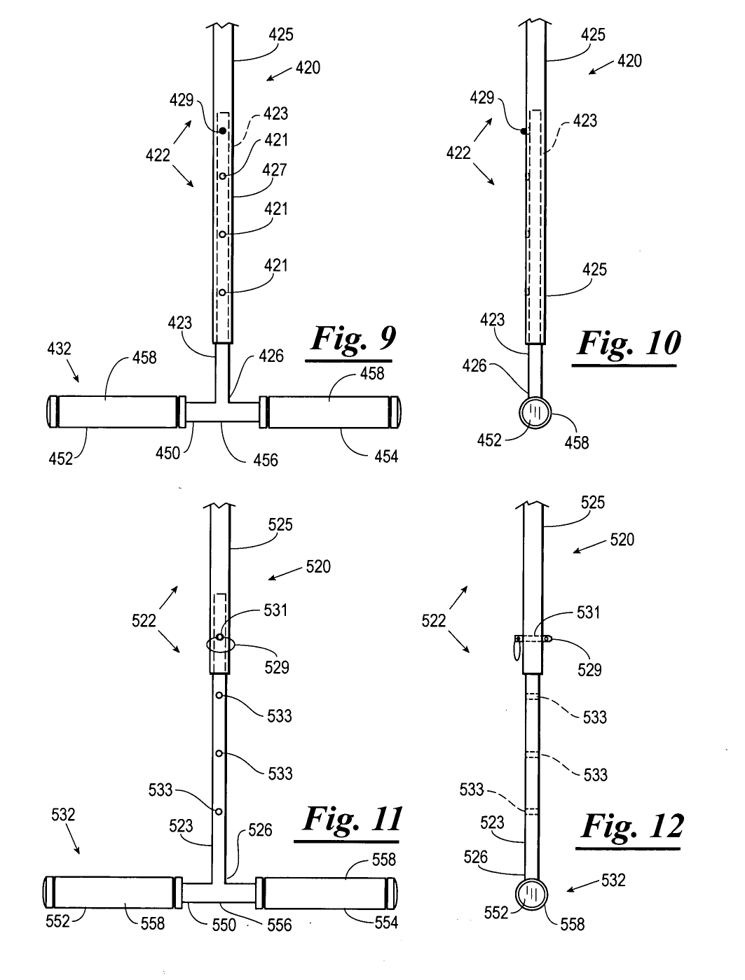

Referring now to FIGS. 9-10, a portion of another fence crossing aid 420 according to applicant's invention is shown. A telescoping vertical member 422 is formed by an inner fitting telescoping vertical member 423 and an outer fitting telescoping vertical member 425. The telescoping vertical member 422 permits the user to adjust the length of the telescoping vertical member 422 as desired. Once adjusted, a push button assembly 429 attached to the inner fitting telescoping vertical member 423 cooperates with a selected mating bore 421 in the outer fitting telescoping vertical member 25 to lock the inner fitting telescoping vertical member 423 in a fixed position with respect to the outer fitting telescoping vertical member 425. A stepping bar assembly 432 consists of a horizontal foot member 450 with end portions 452, 454 and a mid-portion 456. The foot member 450 is attached to the lower end 426 of the inner fitting telescoping vertical member 423 at the horizontal foot member mid-portion 456. Grips 458 attached to the end portions 452, 454 provide a reliable stepping surface for the user.

Referring now to FIGS. 11-12, a portion of another fence crossing aid 520 according to applicant's invention is shown. A telescoping vertical member 522 is formed by an inner fitting telescoping vertical member 523 and an outer fitting telescoping vertical member 525. The telescoping vertical member 522 permits the user to adjust the length of the telescoping member 522 as desired. Once adjusted, a pull pin 529 is inserted through aligned bores 531 in the outer fitting telescoping vertical member 525 and, simultaneously, through one pair of spaced aligned bore pairs 533 in the inner fitting telescoping vertical member 523. A stepping bar assembly 532 consists of a horizontal foot member 550 with end portions 552, 554 and a mid-portion 556. The foot member 550 is attached to the lower end 526 of the inner fitting telescoping vertical member 523 at the horizontal foot member mid-portion 556. Grips 558 attached to the end portions 552, 554 provide a reliable stepping surface for the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A fence crossing aid to assist a user in crossing a fence supported by a T-post, wherein the T-post is characterized as having a rib member, a cross member perpendicular to the rib member, and spaced protrusions on the cross member opposite the rib member, the fence crossing aid comprising:
a vertical member having a bottom portion terminating in a bottom end and an upper portion terminating in an upper end;
a stepping bar assembly attached to the lower end of the vertical member;
a handlebar assembly attached to the upper end of the vertical member;
a strap attached to the bottom portion of the vertical member for securing the vertical member to the T-post; and
an inverted L-shaped mounting head attached to the upper portion of the vertical member so the top of the T-post is received within the inverted L-shaped mounting head and the T-post supports the combined weight of the fence crossing aid and the user.

2. The device of claim 1 wherein the stepping bar assembly further comprises:
a horizontal foot member having two horizontal foot member end portions and a horizontal foot member mid-portion; and
wherein the vertical member is attached to the mid-portion of the horizontal foot member.

3. The device of claim 2, further comprising grips attached to the end portions of the horizontal foot member so a user steps onto the grips when crossing the fence.

4. The device of claim 1 wherein the handlebar assembly further comprises:
a horizontal hand member having two horizontal hand member end portions and a horizontal hand member mid-portion; and
wherein the vertical member is attached to the mid-portion of the horizontal foot member.

5. The device of claim 4 wherein the handlebar assembly further comprises grips attached to the end portions so a user grasps the grips when crossing the fence.

6. The device of claim 1 wherein the strap is a hook-and-loop fastener having two ends, wherein one end of the strap is slidably attached to the vertical member and the other end of the strap secures the vertical member to the T-post.

7. The device of claim 1 wherein the inverted L-shaped mounting head further comprises:
an inverted L-shaped body having a vertical portion and a horizontal portion, and wherein the horizontal portion has a top and a bottom;
a pair of spaced vertical positioning members extending downwardly from the bottom of the horizontal portion of the inverted L-shaped body so the spaced vertical positioning member are substantially parallel to the vertical portion of the inverted L-shaped body; and
wherein the vertical portion of the inverted L-shaped body has a recess extending downwardly from the bottom of the horizontal portion of the inverted L-shaped body, so that, when the inverted L-shaped mounting head is placed over the top of the T-post, the rib member of the T-post is disposed between the positioning members, the cross member of the T-post is disposed between the positioning members and the vertical portion of the inverted L-shaped body of the mounting head, and the protrusions are disposed within the recess.

8. The device of claim 1 wherein the vertical member is a telescoping vertical member.

9. The device of claim 6 wherein the telescoping vertical member further comprises:
an inner fitting telescoping vertical member having a push button assembly mounted therein;
an outer fitting telescoping vertical member having a series of spaced bores cooperating with the push button assembly to hold the inner fitting telescoping vertical member and the outer fitting telescoping vertical member in a selected fixed relationship.

10. The device of claim 7 wherein the telescoping vertical member further comprises:
an inner fitting telescoping vertical member having at least two pairs of spaced aligned bores therein;
an outer fitting telescoping vertical member having a pair of aligned bores therein, so one pair of the at least two pairs of spaced aligned bores in the inner fitting telescoping vertical member can be aligned with the pair of aligned bores in the outer fitting telescoping vertical member; and
a pull pin adapted for insertion through the pair of aligned bores in the outer fitting telescoping vertical member and through one pair of the at least two pairs of spaced aligned bores in the inner fitting telescoping vertical member to hold the outer fitting telescoping vertical member and the inner fitting telescoping vertical member in fixed relationship.

11. The device of claim 1 wherein the stepping bar assembly is pivotally attached to the bottom end of the vertical member.

12. The device of claim 1 wherein the handlebar assembly is pivotally attached to the upper end of the vertical member.

13. A method of crossing a fence supported by a T-post by a person, wherein the person is characterized as having a left hand, a right hand, a left foot, a right foot, and a specified weight, and further wherein the person is crossing from the near side of the fence to the far side of the fence, the method comprising the steps of:
providing a fence crossing aid comprising:
a vertical member having a bottom portion terminating in a bottom end and an upper portion terminating in an upper end;
a stepping bar assembly attached to the lower end of the vertical member, the stepping bar assembly further comprising a horizontal foot member having two horizontal foot member end portions and a horizontal foot member mid-portion and wherein the vertical member is attached to the mid-portion of the horizontal foot member;
a handlebar assembly attached to the upper end of the vertical member, the handlebar assembly further comprising a horizontal hand member having two horizontal hand member end portions and a horizontal hand member mid-portion and wherein the vertical member is attached to the mid-portion of the horizontal foot member;
a strap attached to the bottom portion of the vertical member for securing the vertical member to the T-post; and
an inverted L-shaped mounting head attached to the upper portion of the vertical member;
placing the inverted L-shaped mounting head of the fence crossing aid over the T-post so the top of the T-post is received within the inverted L-shaped mounting head, whereby the vertical member of the fence crossing aid extends downwardly along the T-post and supports the stepping bar assembly so that one horizontal foot member is positioned on the near side of the fence and the other horizontal foot member is positioned on the far side of the fence, and whereby the vertical member extends above the inverted L-shaped mounting head and supports the handlebar assembly so that one horizontal hand member is positioned on the near side of the fence and the other horizontal hand member is positioned on the far side of the fence;
securing the bottom portion of the vertical member using the strap provided herein;
placing the right foot on the near side horizontal foot member;
grasping the far side horizontal hand member in the person's left hand;
grasping the near side horizontal hand member in the person's right hand;
stepping up onto the stepping bar assembly so the person's weight is supported by the person's right foot on the near side horizontal foot member;
swinging the left foot up and over the fence;
placing the left foot on the far side horizontal foot member;
shifting the person's weight so the person's weight is supported by the person's left foot on the far side horizontal foot member;
swinging the right foot up and over the fence;
placing the right foot on the ground;
shifting the person's weight from the person's left foot located on the far side horizontal foot member to the person's right foot located on the ground;
moving the person's left foot from the far side horizontal foot member to the ground;
detaching the strap from the T-post; and
lifting the fence crossing aid upwardly off of the T-post.

14. A method of crossing a fence supported by a T-post by a person, wherein the person is characterized as having a left hand, a right hand, a left foot, a right foot, and a specified weight, and further wherein the person is crossing from the near side of the fence to the far side of the fence, the method comprising the steps of:
providing a fence crossing aid comprising:
a vertical member having a bottom portion terminating in a bottom end and an upper portion terminating in an upper end;
a stepping bar assembly attached to the lower end of the vertical member, the stepping bar assembly further comprising a horizontal foot member having two horizontal foot member end portions and a horizontal foot member mid-portion and wherein the vertical member is attached to the mid-portion of the horizontal foot member;
a handlebar assembly attached to the upper end of the vertical member, the handlebar assembly further comprising a horizontal hand member having two horizontal hand member end portions and a horizontal hand member mid-portion and wherein the vertical member is attached to the mid-portion of the horizontal foot member;
a strap attached to the bottom portion of the vertical member for securing the vertical member to the T-post; and
an inverted L-shaped mounting head attached to the upper portion of the vertical member adjacent the handlebar assembly;
placing the inverted L-shaped mounting head of the fence crossing aid over the T-post so the top of the T-post is received within the inverted L-shaped mounting head, whereby the vertical member of the fence crossing aid extends downwardly along the T-post and supports the stepping bar assembly so that one horizontal foot member is positioned on the near side of the fence and the other horizontal foot member is positioned on the far side of the fence, and whereby the vertical member extends above the inverted L-shaped mounting head and supports the handlebar assembly so that one horizontal hand member is positioned on the near side of the fence and the other horizontal hand member is positioned on the far side of the fence;
securing the bottom portion of the vertical member using the strap provided herein;
placing the left foot on the near side horizontal foot member;
grasping the far side horizontal hand member in the person's right hand;
grasping the near side horizontal hand member in the person's left hand;
stepping up onto the stepping bar assembly so the person's weight is supported by the person's left foot on the near side horizontal foot member;
swinging the right foot up and over the fence;
placing the right foot on the far side horizontal foot member;
shifting the person's weight so the person's weight is supported by the person's right foot on the far side horizontal foot member;
swinging the left foot up and over the fence;
placing the left foot on the ground;
shifting the person's weight from the person's right foot located on the far side horizontal foot member to the person's left foot located on the ground;
moving the person's right foot from the far side horizontal foot member to the ground;
detaching the strap from the T-post; and
lifting the fence crossing aid upwardly off of the T-post.
